(19) United States
(12) Patent Application Publication
(10) Pub. No.: US 2026/0163760 A1
(43) Pub. Date: Jun. 11, 2026

(54) CHANNEL ESTIMATION IN PHYSICAL DOWNLINK CONTROL CHANNELS

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Kirill IVANOV, La Jolla, CA (US); Wei YANG, San Diego, CA (US); Pinar SEN, San Diego, CA (US)

(21) Appl. No.: 18/975,400

(22) Filed: Dec. 10, 2024

(51) Int. Cl. H04L 25/02; H04L 5/00; H04W 8/22

(52) U.S. Cl. CPC H04L 25/0204; H04L 5/0051; H04W 8/22

(57) ABSTRACT

Various aspects of the present disclosure generally relate to wireless communication. In some aspects, a user equipment (UE) may transmit capability information that includes an indication of a capability for performing an additional-resource-element channel estimation. The UE may receive a communication that includes a demodulation reference signal (DMRS), wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted. Numerous other aspects are described.

### FIELD OF THE DISCLOSURE

Aspects of the present disclosure generally relate to wireless communication and specifically relate to techniques, apparatuses, and methods associated with channel estimation in physical downlink control channels.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting capability information that includes an indication of a capability for performing an additional-resource-element channel estimation. The method may include receiving a communication that includes a demodulation reference signal (DMRS), wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

Some aspects described herein relate to a method of wireless communication performed by a network node. The method may include receiving capability information that includes information indicating a capability for performing additional-resource-element channel estimation. The method may include transmitting information indicating whether the additional-resource-element channel estimation is expected to be performed based at least in part on the capability information.

Some aspects described herein relate to a non-transitory computer-readable medium that stores a set of instructions for wireless communication by a UE. The set of instructions, when executed by one or more processors of the UE, may cause the UE to transmit capability information that includes an indication of a capability for performing an additional-resource-element channel estimation. The set of instructions, when executed by one or more processors of the UE, may cause the UE to receive a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

Some aspects described herein relate to a non-transitory computer-readable medium that stores a set of instructions for wireless communication by a network node.

The set of instructions, when executed by one or more processors of the network node, may cause the network node to receive capability information that includes information indicating a capability for performing additional-resource-element channel estimation. The set of instructions, when executed by one or more processors of the network node, may cause the network node to transmit information indicating whether the additional-resource-element channel estimation is expected to be performed based at least in part on the capability information.

Some aspects described herein relate to a UE for wireless communication. The UE may include one or more memories and one or more processors coupled to the one or more memories. The one or more processors may be configured to transmit capability information that includes an indication of a capability for performing an additional-resource-element channel estimation. The one or more processors may be configured to receive a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

Some aspects described herein relate to a network node for wireless communication. The network node may include one or more memories and one or more processors coupled to the one or more memories. The one or more processors may be configured to receive capability information that includes information indicating a capability for performing additional-resource-element channel estimation. The one or more processors may be configured to transmit information indicating whether the additional-resource-element channel estimation is expected to be performed based at least in part on the capability information.

Some aspects described herein relate to an apparatus for wireless communication. The apparatus may include means for transmitting capability information that includes an indication of a capability for performing an additional-resource-element channel estimation. The apparatus may include means for receiving a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

Some aspects described herein relate to an apparatus for wireless communication. The apparatus may include means for receiving capability information that includes information indicating a capability for performing additional-resource-element channel estimation. The apparatus may include means for transmitting information indicating whether the additional-resource-element channel estimation is expected to be performed based at least in part on the capability information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating an example of a channel estimation process, in accordance with the present disclosure.

FIG. 5 is a diagram illustrating an example associated with channel estimation in physical downlink control channels, in accordance with the present disclosure.

FIG. 6 is a diagram illustrating an example process performed, for example, at a user equipment (UE) or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication network may use a demodulation reference signal (DMRS) to improve data demodulation and decoding. For example, a user equipment (UE) may receive a DMRS output by a network node and use the DMRS to estimate the channel over which the data is transmitted. By estimating the channel, the UE can compensate for issues such as fading, delay spread, and phase noise associated with the channel.

In some cases, channel estimation for a physical downlink control channel (PDCCH) may be performed per resource element group (REG) bundle. In some cases, the REG bundles may be defined across resource blocks (RBs) included in a PDCCH control resource set (CORESET). In some cases, a network node may transmit a DMRS via the REG bundles. A UE may receive the DMRS via the REG bundles and may perform one or more measurements of the received DMRS. In some cases, the UE may utilize a result of performing the one or more measurements to determine a channel estimation associated with a communication channel via which the DMRS is received.

Various aspects relate generally to performing channel estimation for a PDCCH based at least in part on resource elements via which a DMRS is transmitted (e.g., one or more REG bundles used to transmit a DMRS) as well as additional resource elements of the PDCCH. Some aspects more specifically relate to utilizing all of the resource elements of a PDCCH to perform channel estimation.

In some aspects, a UE may indicate (e.g., to a network node) a capability of performing channel estimation utilizing all of the resource elements of a PDCCH. In some aspects, channel estimation utilizing all of the resource elements of a PDCCH may be performed based at least in part on a satisfaction of one or more criteria. In some aspects, the one or more criteria may include an estimated improvement in the channel estimation relative to performing channel estimation utilizing only the DMRS satisfying (e.g., being greater than, or equal to) a threshold.

Particular aspects of the subject matter described in this disclosure can be implemented to realize one or more of the following potential advantages. In some examples, the described techniques can be used to enable a wireless communication device (e.g., a network node and/or a UE) to determine more accurate channel estimations (e.g., one or more measurement metrics that satisfy an error threshold) using all resource elements of a PDCCH and, consequently, the described techniques enable the wireless communication device to adjust transmission and/or reception parameters (e.g., beam adjustments, resource allocation adjustments, and/or power level adjustments) to reduce data recovery errors and/or increase data throughput. As one example, more accurate channel estimations may enable the device to mitigate interference and increase link reliability.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

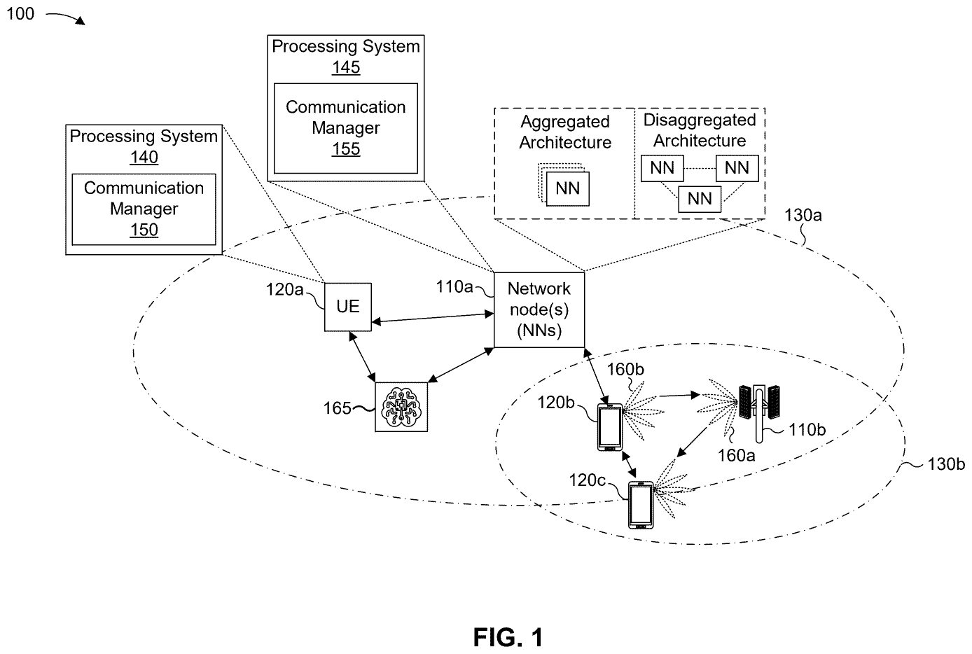

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

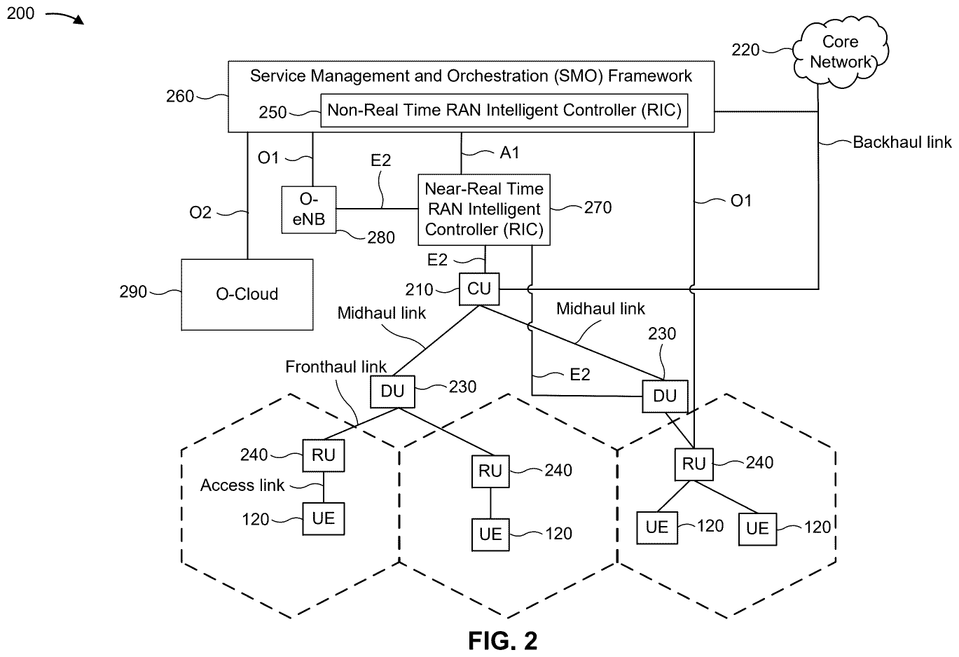

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE 120 may include a communication manager 150. As described in more detail elsewhere herein, the communication manager 150 may transmit capability information that includes an indication of a capability for performing an additional-resource-element channel estimation; and receive a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted. Additionally, or alternatively, the communication manager 150 may perform one or more other operations described herein.

In some aspects, a network node 110 may include a communication manager 155. As described in more detail elsewhere herein, the communication manager 155 may receive capability information that includes information indicating a capability for performing additional-resource-element channel estimation; and transmit information indicating whether the additional-resource-element channel estimation is expected to be performed based at least in part on the capability information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

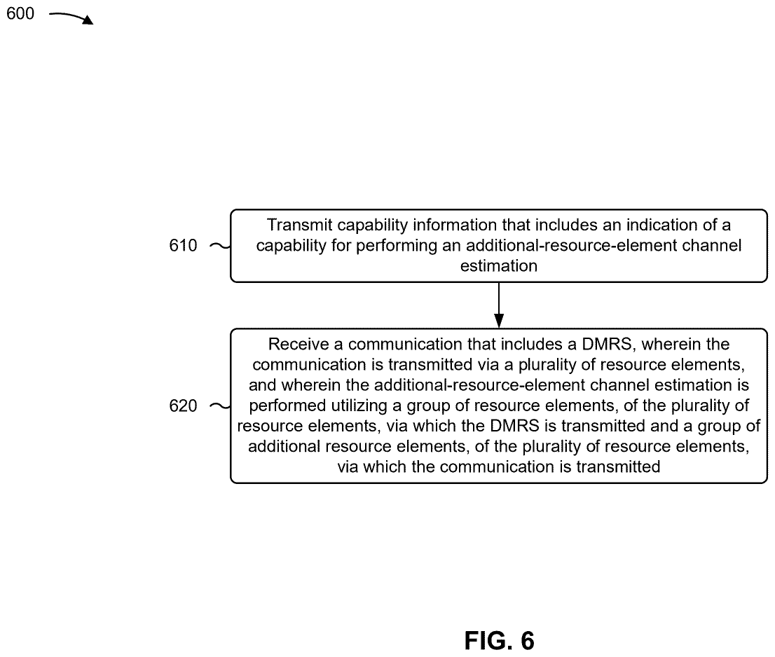

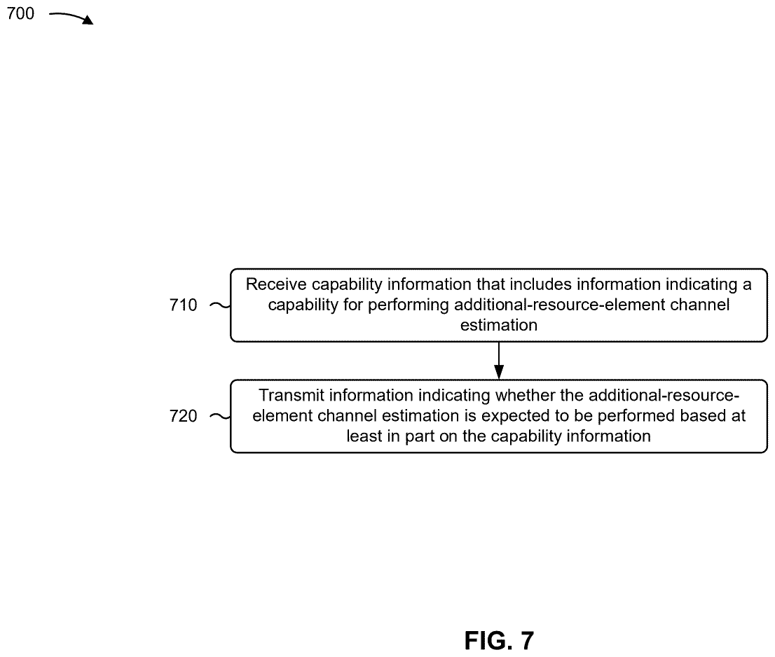

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with channel estimation in PDCCHs, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

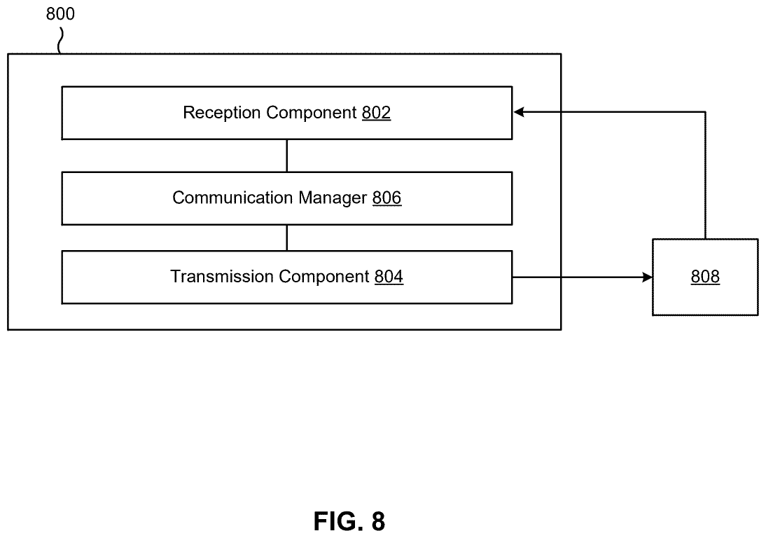

In some aspects, a UE includes means for transmitting capability information that includes an indication of a capability for performing an additional-resource-element channel estimation; and/or means for receiving a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

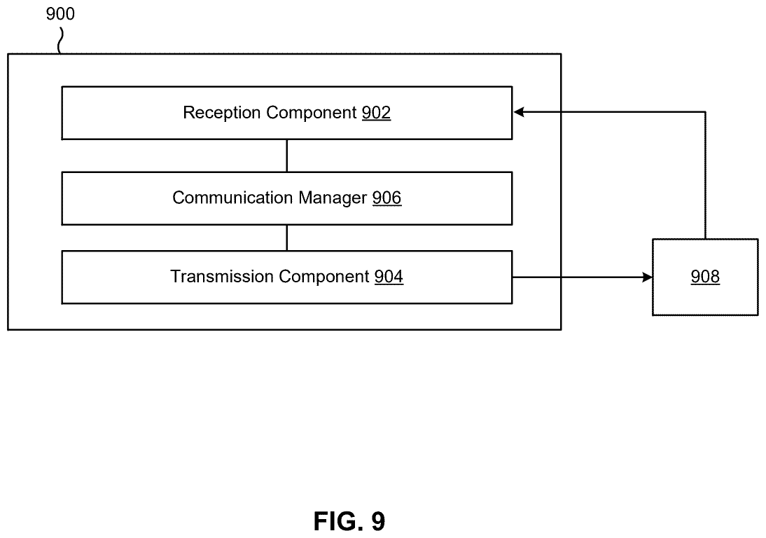

In some aspects, a network node includes means for receiving capability information that includes information indicating a capability for performing additional-resource-element channel estimation; and/or means for transmitting information indicating whether the additional-resource-element channel estimation is expected to be performed based at least in part on the capability information. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

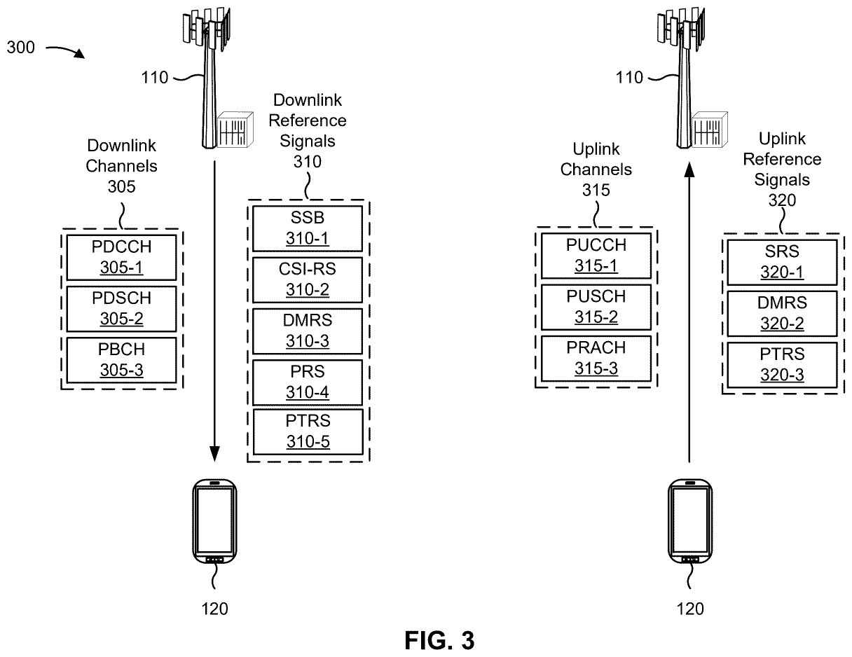

FIG. 3 is a diagram illustrating an example 300 of physical channels and reference signals in a wireless network, in accordance with the present disclosure. As shown in FIG. 3, downlink channels 305 and downlink reference signals 310 may carry information from a network node 110 to a UE 120, and uplink channels 315 and uplink reference signals 320 may carry information from a UE 120 to a network node 110.

As shown, a downlink channel 305 may include a PDCCH 305-1 that carries DCI, a PDSCH 305-2 that carries downlink data, or a PBCH 305-3 that carries system information, among other examples. In some aspects, PDSCH communications may be scheduled by PDCCH communications. As further shown, an uplink channel 315 may include a PUCCH 315-1 that carries UCI, a PUSCH 315-2 that carries uplink data, or a PRACH 315-3 used for initial network access, among other examples. In some aspects, the UE 120 may transmit ACK or NACK feedback (e.g., ACK/NACK feedback or ACK/NACK information) in UCI on the PUCCH 315-1 and/or the PUSCH 315-2.

As further shown, a downlink reference signal 310 may include an SSB 310-1, a CSI-RS 310-2, a DMRS 310-3, a positioning reference signal (PRS) 310-4, or a PTRS 310-5, among other examples. As also shown, an uplink reference signal 320 may include an SRS 320-1, a DMRS 320-2, or a PTRS 320-3, among other examples.

An SSB 310-1 may carry information used for initial network acquisition and synchronization, such as a PSS, an SSS, a PBCH 305-3, and a PBCH DMRS (e.g., a DMRS 310-3 transmitted via a PBCH 305-3). An SSB 310-1 is sometimes referred to as a synchronization signal/PBCH (SS/PBCH) block. In some aspects, the network node 110 may transmit multiple SSBs 310-1 on multiple corresponding beams, and the SSBs 310-1 may be used for beam selection.

A CSI-RS 310-2 may carry information used for downlink channel estimation (e.g., downlink CSI acquisition), which may be used for scheduling, link adaptation, or beam management, among other examples. The network node 110 may configure a set of CSI-RSs 310-2 for the UE 120, and the UE 120 may measure the configured set of CSI-RSs 310-2. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS 310-3, 320-2 may carry information used to estimate a radio channel for demodulation of an associated physical channel (e.g., a PDCCH 305-1, a PDSCH 305-2, a PBCH 305-3, a PUCCH 315-1, or a PUSCH 315-2). The design and mapping of a DMRS 310-3, 320-2 may be specific to a physical channel for which the DMRS 310-3, 320-2 is used for estimation. DMRSs 310-3, 320-2 are UE-specific, can be beamformed, can be confined in a scheduled resource (e.g., rather than transmitted on a wideband), and can be transmitted only when necessary. As shown, DMRSs 310-3, 320-2 are used for both downlink communications (e.g., DMRS 310-3) and uplink communications (e.g., DMRS 320-2).

A PTRS 310-5, 320-3 may carry information used to compensate for oscillator phase noise. Typically, the phase noise increases as the oscillator carrier frequency increases. Thus, a PTRS 310-5, 320-3 can be utilized at high carrier frequencies, such as millimeter wave frequencies, to mitigate phase noise. The PTRS 310-5, 320-3 may be used to track the phase of the local oscillator and to enable suppression of phase noise and common phase error (CPE). As shown, PTRSs 310-5, 320-3 are used for both downlink communications (e.g., a PTRS 310-5 transmitted via the PDSCH 305-2) and uplink communications (e.g., a PTRS 310-5 transmitted via the PUSCH 315-2).

A PRS 310-4 may carry information used to enable timing or ranging measurements of the UE 120 based on signals transmitted by the network node 110 to improve observed time difference of arrival (OTDOA) positioning performance. For example, a PRS 310-4 may be a pseudo-random Quadrature Phase Shift Keying (QPSK) sequence mapped in diagonal patterns with shifts in frequency and time to avoid collision with cell-specific reference signals and control channels (e.g., a PDCCH 305-1). In general, a PRS 310-4 may be designed to improve detectability by the UE 120, which may need to detect downlink signals from multiple neighboring network nodes 110 in order to perform OTDOA-based positioning. Accordingly, the UE 120 may receive a PRS 310-4 from multiple cells (e.g., a reference cell and one or more neighbor cells), and may report a reference signal time difference (RSTD) based on OTDOA measurements associated with the PRSs 310-4 received from the multiple cells. In some aspects, the network node 110 may then calculate a position of the UE 120 based on the RSTD measurements reported by the UE 120.

An SRS 320-1 may carry information used for uplink channel estimation, which may be used for scheduling, link adaptation, precoder selection, or beam management, among other examples. The network node 110 may configure one or more SRS resource sets for the UE 120, and the UE 120 may transmit SRSs 320-1 on the configured SRS resource sets. An SRS resource set may have a configured usage, such as uplink CSI acquisition, downlink CSI acquisition for reciprocity-based operations, uplink beam management, among other examples. The network node 110 may measure the SRSs 320-1, may perform channel estimation based at least in part on the measurements, and may use the SRS measurements to configure communications with the UE 120.

As indicated above, FIG. 3 is provided as an example. Other examples may differ from what is described with regard to FIG. 3.

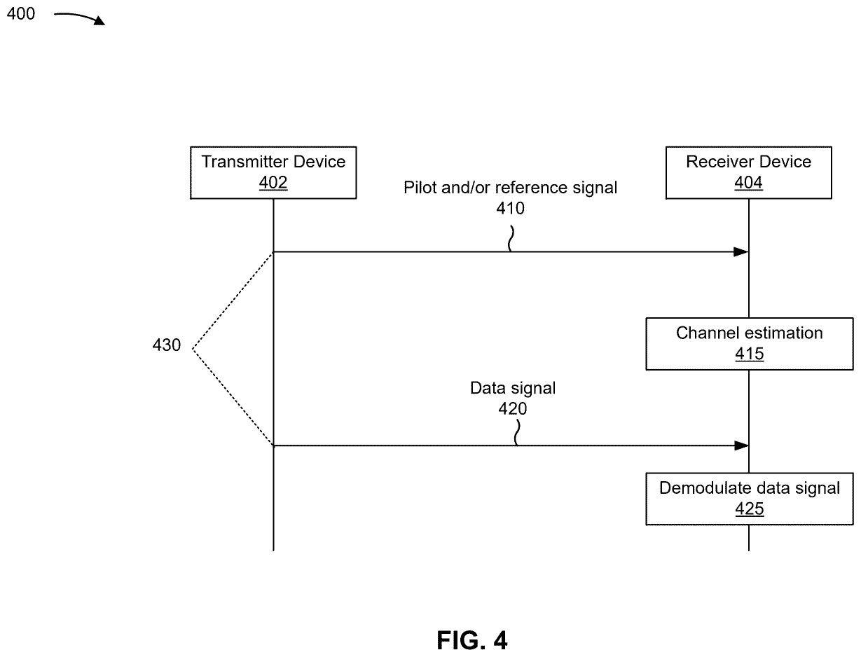

FIG. 4 is a diagram illustrating an example 400 of a channel estimation process, in accordance with the present disclosure.

In a wireless network, a signal is transmitted from a transmitter device 402 (e.g., a network node 110 or a UE 120) to a receiver device 404 (e.g., a UE 120 or a network node 110) over a wireless channel. While the signal is traveling over the wireless channel, the signal may be distorted and/or noise may be added to the signal due to various factors. For example, the signal may be subject to attenuation, phase shift, scattering, power decay, large scale fading, small scale fading, interference experienced by the transmitter device 402, interference experienced by the receiver device 404, and/or capabilities of the transmitter device 402 and/or the receiver device 404 (e.g., multi-antenna capabilities and/or maximum transmission power), among other examples. To adapt transmission parameters and/or reception parameters in order to ensure that the signal can be received and properly decoded by the receiver device, the transmitter device 402 and/or the receiver device 404 may perform channel estimation to learn characteristics of the wireless channel between the transmitter device 402 and the receiver device 404, and correct for any distortion or noise in the wireless channel.

To illustrate, before each transmission and/or at periodic intervals, the transmitter device 402 may transmit a pilot signal and/or reference signals in the wireless channel, as shown by reference number 410. Examples of a pilot signal and/or reference signal may include a CSI-RS, a DMRS, a PTRS, and/or an SRS. As shown by reference number 415, the receiver device 404 may compute a channel estimation using the pilot signal and/or reference signal, such as by calculating a correlation between properties associated with the transmitted pilot signal and/or transmitted reference signal and properties associated with the received pilot signal and/or received reference signal. The transmitter device 402 may transmit a data signal, as shown by reference number 420, and the receiver device may use the estimated wireless channel to demodulate the data signal, as shown by reference number 425. As shown by reference number 430, the transmitter device 402 may transmit the pilot signal and/or reference signal in a same transmission as the data signal. For instance, the transmitter device 402 may be a network node that transmits a PDSCH transmission that carries a DMRS and user data. Alternatively, the transmitter device 402 may be a UE that transmits a PUSCH transmission that carries a DMRS and user data.

In other examples, the transmitter device 402 may transmit the pilot signal and/or reference signal in a different transmission than the data signal, such as a network node that transmits a CSI-RS that is used by a UE to estimate a downlink wireless channel and/or a UE that transmits an SRS that is used by a network node to estimate an uplink wireless channel.

A wireless communication device, such as a network node and/or a UE, may learn characteristics and/or properties of a wireless channel based at least in part on measuring a reference signal. However, these characteristics and/or properties may be highly dynamic based at least in part on a variety of factors. As one example, device mobility may affect positions and/or relative positions of devices that result in changes to the state of a wireless channel between a transmitter device (e.g., the transmitter device 402) and a receiver device (e.g., the receiver device 404). As another example, physical properties of the wireless environment surrounding the transmitter device and/or the receiver device may result in changes to the state of the wireless channel, such as objects that may reflect, scatter, and/or block wireless signals. Accordingly, in a wireless environment where the presence and/or movement of devices and/or objects dynamically vary, channel estimation may be used to dynamically adapt transmission parameters to improve a link reliability (e.g., decrease recovery errors, reduce data transfer latency, and/or increase data throughput).

As indicated above, FIG. 4 is provided as an example. Other examples may differ from what is described with regard to FIG. 4.

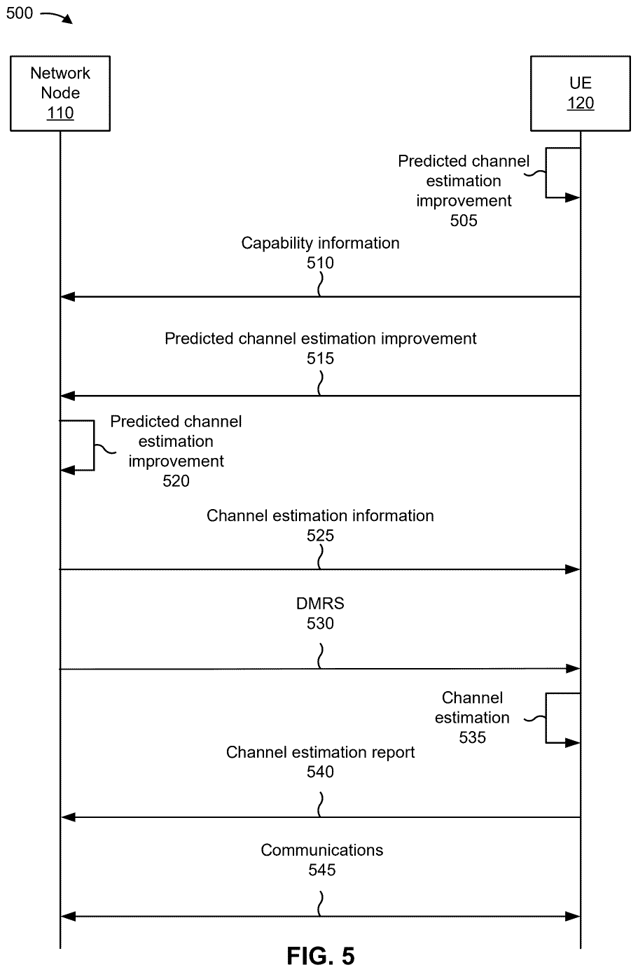

FIG. 5 is a diagram illustrating an example 500 associated with channel estimation in PDCCHs, in accordance with the present disclosure. As shown in FIG. 5, a network node 110 and a UE 120 may communicate with one another.

As shown by reference number 505, the UE 120 may determine a predicted channel estimation improvement associated with utilizing a first type of channel estimation procedure relative to using a second type of channel estimation procedure.

In some aspects, the first type of channel estimation procedure may be a procedure or method for performing an additional-resource-element channel estimation and the second type of channel estimation procedure may be a procedure or method for performing channel estimation utilizing a group of resource elements via which a DMRS is transmitted.

In some aspects, the additional-resource-element channel estimation may comprise performing channel estimation utilizing the group of resource elements via which the DMRS is transmitted and a group of additional resource elements. For example, the DMRS may be included in a communication that is transmitted via a plurality of resource elements.

In some aspects, the DMRS is transmitted via a group of resource elements of the plurality of resources. The additional-resource-element channel estimation may include performing a channel estimation for a communication channel (e.g., a PDCCH or a PDSCH) via which the communication is transmitted, utilizing the group of resource elements via which the DMRS is transmitted and a group of one or more additional resource elements of the plurality of resource elements via which the communication is transmitted.

In some aspects, the group of one or more additional resource elements and the group of resources via which the DMRS is transmitted include all of the resource elements of the plurality of resources elements via which the communication is transmitted. In some aspects, the group of one or more additional resource elements and the group of resources via which the DMRS is transmitted comprise a portion of the resource elements of the plurality of resources elements via which the communication is transmitted.

In some aspects, the UE 120 may estimate or predict a result of performing the first type of channel estimation procedure for a downlink channel (e.g., a PDCCH or a PDSCH). In some aspects, the UE 120 may utilize a Viterbi algorithm to estimate or predict the result of performing the first type of channel estimation procedure for the downlink channel. In some aspects, the Viterbi algorithm may be a recursive algorithm optimal to the problem of estimating the state sequence of a discrete-time finite-state Markov process observed in memoryless noise.

In some aspects, the UE 120 may estimate or predict a result of performing the second type of channel estimation procedure for the downlink channel. In some aspects, the UE 120 may utilize a Viterbi algorithm to estimate or predict the result of performing the second type of channel estimation procedure for the downlink channel.

In some aspects, the UE 120 may compare the estimated or predicted result of performing the first type of channel estimation procedure and the estimated or predicted result of performing the second type of channel estimation procedure. In some aspects, the UE 120 may determine a predicted channel estimation improvement based at least in part on the comparison.

As an example, the UE 120 may determine a difference between a value of a channel estimation parameter (e.g., a signal-to-noise ratio) included in the result of performing the first type of channel estimation procedure and a value of a corresponding channel estimation parameter included in the result of performing the second type of channel estimation procedure. The UE 120 may determine the predicted channel estimation improvement based at least in part on the difference between the values. In some aspects, the UE 120 may determine the predicted channel estimation improvement based at least in part on comparing values of a group of parameters included in the result of performing the first type of channel estimation procedure and values of a corresponding group of channel estimation parameters included in the result of performing the second type of channel estimation procedure.

In some aspects, the group of resource elements may include one or more resource element group bundles. In some aspects, the predicted channel estimation improvement may be determined based at least in part on a size of a resource element group bundle. For example, the predicted channel estimation improvement may be determined based at least in part on comparing values of a group of parameters associated with a resource element group bundle included in the result of performing the first type of channel estimation procedure and values of a corresponding group of channel estimation parameters included in the result of performing the second type of channel estimation procedure.

In some aspects, the UE 120 may determine multiple predicted channel estimation improvements. For example, the UE 120 may determine a predicted channel estimation improvement per frequency range, per frequency band, and/or for one or more combinations of frequency bands.

As shown by reference number 510, the UE 120 may transmit, and the network node 110 may receive, capability information associated with the UE 120. In some aspects, the capability information may include information indicating that the UE 120 is capable of performing the first type of channel estimation procedure and/or the second type of channel estimation procedure.

In some aspects, the capability information may include information indicating that the UE 120 is capable of performing the first type of channel estimation procedure based at least in part on the predicted channel estimation improvement satisfying (e.g., being greater than, or equal to) an improvement threshold. For example, the predicted channel estimation improvement may indicate a difference between an estimated or predicted signal-to-noise ratio associated with utilizing the first type of channel estimation procedure and an estimated or predicted signal-to-noise ratio associated with utilizing the second type of channel estimation procedure.

In some aspects, the UE 120 may determine whether the difference between the signal-to-noise ratios satisfies a threshold. In some aspects, the capability information may include information indicating that the UE 120 is capable of performing the first type of channel estimation procedure based at least in part on the difference between the signal-to-noise ratios satisfying the threshold. In some aspects, the capability information may not indicate that the UE 120 is capable of performing the first type of channel estimation procedure based at least in part on the difference between the signal-to-noise ratios failing to satisfy the threshold.

As shown by reference number 515, the UE 120 may transmit, and the network node 110 may receive, information indicating the predicted channel estimation improvement. In some aspects, the information indicating the predicted channel estimation improvement may be included in the capability information. In some aspects, the capability information may include the information indicating the predicted channel estimation improvement based at least in part on the predicted channel estimation improvement satisfying (e.g., being greater than, or equal to) an improvement threshold. In some aspects, the capability information may include the information indicating the predicted channel estimation improvement based at least in part on the predicted channel estimation improvement failing to satisfy (e.g., being less than) the improvement threshold.

In some aspects, the information indicating the predicted channel estimation improvement may be transmitted separately from the capability information. For example, the network node 110 may receive the capability information and may determine that the UE 120 is capable of performing the first type of channel estimation procedure. The network node 110 may transmit a request for the predicted channel estimation improvement based at least in part on the UE 120 being capable of performing the predicted channel estimation improvement. The UE 120 may transmit the information indicating the predicted channel estimation improvement to the network node 110 based at least in part on the request.

As shown by reference number 520, the network node 110 may determine the predicted channel estimation improvement. In some aspects, the network node 110 may determine the predicted channel estimation improvement based at least in part on the information indicating the predicted channel estimation improvement.

In some aspects, the network node 110 may determine the predicted channel estimation improvement in a manner similar to that described above with respect to the UE 120 determining the predicted channel estimation improvement. In some aspects, the network node 110 may determine the predicted channel estimation improvement, based at least in part on the network node 110 failing to receive the information indicating the predicted channel estimation improvement.

For example, the UE 120 may refrain from transmitting the information indicating the predicted channel estimation improvement to the network node 110 based at least in part on the UE 120 refraining from determining the predicted channel estimation improvement or based at least in part on the predicted channel estimation improvement failing to satisfy the improvement threshold, among other examples.

In some aspects, the network node 110 may determine the predicted channel estimation improvement in order to enable the network node 110 to compare the predicted channel estimation improvement determined by the UE 120 and the predicted channel estimation improvement determined by the network node 110. In some aspects, the network node 110 may determine whether a difference between the predicted channel estimation improvement determined by the UE 120 and the predicted channel estimation improvement determined by the network node 110 satisfies (e.g., is less than) a threshold.

In some aspects, the network node 110 may determine a type of channel estimation to be performed by the UE 120 based at least in part on the predicted channel estimation improvement determined by the UE 120, the predicted channel estimation improvement determined by the network node 110, and/or the difference between the predicted channel estimation improvement determined by the UE 120 and the predicted channel estimation improvement determined by the network node 110. In some aspects, the network node 110 may determine that the UE 120 is to perform the first type of channel estimation procedure or the second type of channel estimation procedure based at least in part on whether the predicted channel estimation improvement determined by the UE 120, the predicted channel estimation improvement determined by the network node 110, and/or the difference between the predicted channel estimation improvement determined by the UE 120 and the predicted channel estimation improvement determined by the network node 110 satisfy one or more thresholds.

For example, the network node 110 may determine that the UE 120 is to perform the first type of channel estimation procedure based at least in part on the predicted channel estimation improvement determined by the UE 120 and/or the predicted channel estimation improvement determined by the network node 110 satisfying a first threshold. The network node 110 may determine that the UE 120 is to perform the second type of channel estimation procedure based at least in part on the predicted channel estimation improvement determined by the UE 120 and/or the predicted channel estimation improvement determined by the network node 110 failing to satisfy the first threshold.

Additionally, or alternatively, the network node 110 may determine that the UE 120 is to perform the first type of channel estimation procedure based at least in part on the difference between the predicted channel estimation improvement determined by the UE 120 and the predicted channel estimation improvement determined by the network node 110 satisfying a second threshold. The network node 110 may determine that the UE 120 is to perform the second type of channel estimation procedure based at least in part on the difference between the predicted channel estimation improvement determined by the UE 120 and the predicted channel estimation improvement determined by the network node 110 failing to satisfy the second threshold.

In some aspects, the network node 110 may determine the type of channel estimation procedure to be performed by the UE 120 per frequency range, per frequency band, per combinations of frequency bands, and/or per search space, among other examples. In some aspects, the network node 110 may determine that the UE 120 is to perform the same type of channel estimation for each frequency range, for each frequency band, for each combination of frequency bands, and/or for each search space. In some aspects, the network node 110 may determine that the UE 120 is to perform different types of channel estimation for different frequency ranges, for different frequency bands, for different combination of frequency bands, and/or for different search spaces.

As shown by reference number 525, the network node 110 may transmit, and the UE 120 may receive, channel estimation information. In some aspects, the channel estimation information may indicate a type of channel estimation procedure to be performed by the UE 120. In some aspects, the channel estimation information may indicate the type of channel estimation procedure to be performed by the UE 120 per frequency range, per frequency band, per combinations of frequency bands, and/or per search space, among other examples, as described above.

In some aspects, the channel estimation information may indicate that the UE 120 is to perform the first type of channel estimation procedure. In these aspects, the channel estimation information may indicate a blind detection factor associated with the first type of channel estimation procedure. For example, to limit a quantity of blind detections at the UE 120, which may relate to decoding performance and UE resource utilization, the network node 110 may configure a limit on a quantity of covered control channel elements (CCEs) to use for PDCCH candidates. For example, the network node 110 may configure kl covered CCEs for PDCCH candidates.

In such an example, the network node 110 may select a value for kl, such that a product of kl and a blind detection factor does not exceed a threshold (e.g., a blind detection limit) to ensure that demodulation complexity does not exceed a UE capability. For example, when transmitting signals associated with CCEs, the network node 110 may determine whether k/multiplied by a blind detection factor (e.g., 2 or 4, among other examples) exceeds a threshold corresponding to the blind detection limit.

In some aspects, the channel estimation information may indicate that the UE 120 is to perform the second type of channel estimation procedure. In these aspects, the channel estimation information may not indicate a blind detection factor associated with the second type of channel estimation procedure. The network node 110 may select a value for kl, such that the value of kl (rather than a product of kl and a blind detection factor) does not exceed a threshold (e.g., a blind detection limit).

As shown by reference number 530, the network node 110 may transmit a communication that includes the DMRS. In some aspects, the network node 110 may transmit the communication via a plurality of resource elements of a downlink communication channel (e.g., a PDCCH or a PDSCH).

As shown by reference number 535, the UE 120 may perform channel estimation based at least in part on the channel estimation type indicated by the channel estimation information. In some aspects, the channel estimation information may indicate that the UE 120 is to perform channel estimation using the second type of channel estimation procedure. In some aspects, the UE 120 may perform channel estimation using the second type of channel estimation procedure based at least in part on the channel estimation factor indicating the second type of channel estimation procedure.

In some aspects, the UE 120 may perform channel estimation using the first type of channel estimation procedure even though the channel estimation information indicates the second type of channel estimation procedure. In these aspects, the network node 110 may not assume that the UE 120 will utilize the first type of channel estimation procedure and may select a value for kl, such that the value of kl (rather than a product of kl and a blind detection factor) does not exceed a threshold (e.g., a blind detection limit).

In some aspects, the channel estimation information may indicate that the UE 120 is to perform channel estimation using the first type of channel estimation procedure. In these aspects, the UE 120 may perform the channel estimation using the first type of channel estimation procedure based at least in part on the channel estimation information indicating that the UE 120 is to perform channel estimation using the first type of channel estimation procedure.

As shown by reference number 540, the UE 120 may transmit, and the network node 110 may receive, a channel estimation report. In some aspects, the channel estimation report may include information indicating a result of the UE 120 performing channel estimation using the first type of channel estimation procedure and/or the second type of channel estimation procedure.

As shown by reference number 545, the UE 120 and the network node 110 may communicate based at least in part on the information indicating the result of the UE 120 performing channel estimation using the first type of channel estimation procedure and/or the second type of channel estimation procedure. For example, the UE 120 and/or the network node 110 may utilize the information included in the channel estimation report to dynamically adapt transmission parameters to improve a link reliability (e.g., decrease recovery errors, reduce data transfer latency, and/or increase data throughput).

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with channel estimation in PDCCHs.

As shown in FIG. 6, in some aspects, process 600 may include transmitting capability information that includes an indication of a capability for performing an additional-resource-element channel estimation (block 610). For example, the UE (e.g., using transmission component 804 and/or communication manager 806, depicted in FIG. 8) may transmit capability information that includes an indication of a capability for performing an additional-resource-element channel estimation, as described above.

As further shown in FIG. 6, in some aspects, process 600 may include receiving a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted (block 620). For example, the UE (e.g., using reception component 802 and/or communication manager 806, depicted in FIG. 8) may receive a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted, as described above.

Process 600 may include additional aspects, such as any single aspect or any combination of aspects described below and/or in connection with one or more other processes described elsewhere herein.

In a first aspect, the communication comprises a PDCCH or a PDSCH.

In a second aspect, alone or in combination with the first aspect, the resource elements via which the DMRS is transmitted and the group of additional resource elements comprise all of the resource elements via which the communication is transmitted.

In a third aspect, alone or in combination with one or more of the first and second aspects, the capability information includes an indication of an expected improvement of a channel estimation parameter based at least in part on the UE performing the additional-resource-element channel estimation relative to the UE utilizing only the DMRS to perform a channel estimation.

In a fourth aspect, alone or in combination with one or more of the first through third aspects, the channel estimation parameter comprises a signal-to-noise ratio.

In a fifth aspect, alone or in combination with one or more of the first through fourth aspects, the group of resource elements via which the DMRS is transmitted comprises one or more resource element group bundles, and the expected improvement of the channel estimation parameter is determined based at least in part on a size of a resource element group bundle of the one or more resource element group bundles.

In a sixth aspect, alone or in combination with one or more of the first through fifth aspects, the indication of the capability for performing the additional-resource-element channel estimation is included in the capability information based at least in part on a difference, between an expected value of a channel estimation parameter that is determined based at least in part on performing the additional-resource-element channel estimation, and an expected value of the channel estimation parameter that is determined based at least in part on utilizing only the DMRS to perform the channel estimation, satisfying a threshold.

In a seventh aspect, alone or in combination with one or more of the first through sixth aspects, the group of resource elements via which the DMRS is transmitted comprises one or more resource element group bundles, and the indication of the capability for performing the additional-resource-element channel estimation is included in the capability information based at least in part on a size of a resource element group bundle of the one or more resource element group bundles.

In an eighth aspect, alone or in combination with one or more of the first through seventh aspects, the indication of the capability for performing the additional-resource-element channel estimation includes an indication of whether the UE is capable of performing the additional-resource-element channel estimation per frequency range configured for the UE, per frequency band configured for the UE, per frequency band combination configured for the UE, or a combination thereof.

In a ninth aspect, alone or in combination with one or more of the first through eighth aspects, process 600 includes receiving information indicating that the additional-resource-element channel estimation is to be performed, wherein the additional-resource-element channel estimation is performed based at least in part on receiving the indication.

In a tenth aspect, alone or in combination with one or more of the first through ninth aspects, process 600 includes receiving information indicating that the additional-resource-element channel estimation is not expected to be performed, and performing the additional-resource-element channel estimation.

In an eleventh aspect, alone or in combination with one or more of the first through tenth aspects, process 600 includes transmitting a channel estimation report indicating a result of performing the additional-resource-element channel estimation.

In a twelfth aspect, alone or in combination with one or more of the first through eleventh aspects, a first quantity of covered CCEs associated with a PDCCH is modified based at least in part on the additional-resource-element channel estimation being performed.

In a thirteenth aspect, alone or in combination with one or more of the first through twelfth aspects, performing channel estimation utilizing only the DMRS is associated with a second quantity of CCEs associated with the PDCCH, wherein the first quantity of CCEs corresponds to the second quantity of CCEs multiplied by a factor, and wherein the factor is an integer that is greater than one.

In a fourteenth aspect, alone or in combination with one or more of the first through thirteenth aspects, process 600 includes receiving information indicating whether the additional-resource-element channel estimation is expected to be performed for each search space of a group of search spaces associated with the UE.

In a fifteenth aspect, alone or in combination with one or more of the first through fourteenth aspects, a quantity of covered CCEs associated with a PDCCH for a search space, of the group of search spaces, comprises a first quantity based at least in part on the additional-resource-element channel estimation is expected to be performed for the search space and comprises a second quantity based at least in part on the additional-resource-element channel estimation is not expected to be performed for the search space.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with channel estimation in PDCCHs.

As shown in FIG. 7, in some aspects, process 700 may include receiving capability information that includes information indicating a capability for performing additional-resource-element channel estimation (block 710). For example, the network node (e.g., using reception component 902 and/or communication manager 906, depicted in FIG. 9) may receive capability information that includes information indicating a capability for performing additional-resource-element channel estimation, as described above.

As further shown in FIG. 7, in some aspects, process 700 may include transmitting information indicating whether the additional-resource-element channel estimation is expected to be performed based at least in part on the capability information (block 720). For example, the network node (e.g., using transmission component 904 and/or communication manager 906, depicted in FIG. 9) may transmit information indicating whether the additional-resource-element channel estimation is expected to be performed based at least in part on the capability information, as described above.

Process 700 may include additional aspects, such as any single aspect or any combination of aspects described below and/or in connection with one or more other processes described elsewhere herein.

In a first aspect, process 700 includes transmitting a communication that includes a DMRS, and receiving a channel estimation report indicating a result of the additional-resource-element channel estimation being performed, wherein channel estimation is performed utilizing a group of resource elements via which the DMRS is transmitted and a group of additional resource elements via which the communication is transmitted.

In a second aspect, alone or in combination with the first aspect, the communication comprises a PDCCH or a PDSCH.

In a third aspect, alone or in combination with one or more of the first and second aspects, the resource elements via which the DMRS is transmitted and the group of additional resource elements comprise all of the resource elements via which the communication is transmitted.

In a fourth aspect, alone or in combination with one or more of the first through third aspects, the capability information includes an indication of an expected improvement of a channel estimation parameter based at least in part on performing the additional-resource-element channel estimation relative to utilizing only the DMRS to perform the channel estimation, and whether the additional-resource-element channel estimation is expected to be performed is determined based at least in part on the expected improvement of the channel estimation parameter.

In a fifth aspect, alone or in combination with one or more of the first through fourth aspects, the channel estimation parameter comprises a signal-to-noise ratio.

In a sixth aspect, alone or in combination with one or more of the first through fifth aspects, the information indicating whether the additional-resource-element channel estimation is expected to be performed is determined based at least in part on whether a difference between a first value and a second value satisfies a threshold, wherein the first value corresponds to an expected value of a channel estimation parameter that is determined based at least in part on performing the additional-resource-element channel estimation, and wherein the second value corresponds to an expected value of the channel estimation parameter that is determined based at least in part on utilizing only the DMRS to perform the channel estimation.

In a seventh aspect, alone or in combination with one or more of the first through sixth aspects, a validity of the information indicating the capability for performing the additional-resource-element channel estimation is determined based at least in part on a size of a resource element group utilized to transmit a DMRS.

In an eighth aspect, alone or in combination with one or more of the first through seventh aspects, the information indicating the capability for performing the additional-resource-element channel estimation includes an indication of capability for performing the additional-resource-element channel estimation per configured frequency range, per configured frequency band, per configured frequency band combination, or a combination thereof.

In a ninth aspect, alone or in combination with one or more of the first through eighth aspects, a first quantity of covered CCEs associated with a PDCCH is modified based at least in part on the additional-resource-element channel estimation being performed.

In a tenth aspect, alone or in combination with one or more of the first through ninth aspects, performing channel estimation utilizing only a group of resource elements via which a DMRS is transmitted is associated with a second quantity of CCEs associated with the PDCCH, wherein the first quantity of CCEs corresponds to the second quantity of CCEs multiplied by a factor, and wherein the factor comprises an integer that is greater than one.

In an eleventh aspect, alone or in combination with one or more of the first through tenth aspects, process 700 includes transmitting information indicating whether the additional-resource-element channel estimation is expected to be performed for each search space of a group of search spaces associated with a UE.

In a twelfth aspect, alone or in combination with one or more of the first through eleventh aspects, a quantity of covered CCEs associated with a PDCCH for a search space, of the group of search spaces, comprises a first quantity when the additional-resource-element channel estimation is expected to be performed for the search space and comprises a second quantity when the additional-resource-element channel estimation is not expected to be performed for the search space.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit capability information that includes an indication of a capability for performing an additional-resource-element channel estimation. The reception component 802 may receive a communication that includes a DMRS, wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

The reception component 802 may receive information indicating that the additional-resource-element channel estimation is to be performed, wherein the additional-resource-element channel estimation is performed based at least in part on receiving the indication.

The reception component 802 may receive information indicating that the additional-resource-element channel estimation is not expected to be performed.

The communication manager 806 may perform the additional-resource-element channel estimation.

The transmission component 804 may transmit a channel estimation report indicating a result of performing the additional-resource-element channel estimation.

The reception component 802 may receive information indicating whether the additional-resource-element channel estimation is expected to be performed for each search space of a group of search spaces associated with the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive capability information that includes information indicating a capability for performing additional-resource-element channel estimation. The transmission component 904 may transmit information indicating whether the additional-resource-element channel estimation is expected to be performed based at least in part on the capability information.

The transmission component 904 may transmit a communication that includes a DMRS.

The reception component 902 may receive a channel estimation report indicating a result of the additional-resource-element channel estimation being performed, wherein channel estimation is performed utilizing a group of resource elements via which the DMRS is transmitted and a group of additional resource elements via which the communication is transmitted.

The transmission component 904 may transmit information indicating whether the additional-resource-element channel estimation is expected to be performed for each search space of a group of search spaces associated with a UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a UE, comprising: transmitting capability information that includes an indication of a capability for performing an additional-resource-element channel estimation; and receiving a communication that includes a DMRS, the communication is transmitted via a plurality of resource elements, and the additional-resource-element channel estimation is performed utilizing a group of resource elements, of the plurality of resource elements, via which the DMRS is transmitted and a group of additional resource elements, of the plurality of resource elements, via which the communication is transmitted.
Aspect 2: The method of Aspect 1, wherein the communication comprises a PDCCH or a PDSCH.
Aspect 3: The method of any of Aspects 1-2, wherein the resource elements via which the DMRS is transmitted and the group of additional resource elements comprise all of the resource elements via which the communication is transmitted.
Aspect 4: The method of any of Aspects 1-3, wherein the capability information includes an indication of an expected improvement of a channel estimation parameter based at least in part on the UE performing the additional-resource-element channel estimation relative to the UE utilizing only the DMRS to perform a channel estimation.
Aspect 5: The method of Aspect 4, wherein the channel estimation parameter comprises a signal-to-noise ratio.
Aspect 6: The method of Aspect 4, wherein the group of resource elements via which the DMRS is transmitted comprises one or more resource element group bundles, and the expected improvement of the channel estimation parameter is determined based at least in part on a size of a resource element group bundle of the one or more resource element group bundles.
Aspect 7: The method of any of Aspects 1-6, wherein the indication of the capability for performing the additional-resource-element channel estimation is included in the capability information based at least in part on a difference, between an expected value of a channel estimation parameter that is determined based at least in part on performing the additional-resource-element channel estimation, and an expected value of the channel estimation parameter that is determined based at least in part on utilizing only the DMRS to perform the channel estimation, satisfying a threshold.
Aspect 8: The method of Aspect 7, wherein the channel estimation parameter comprises a signal-to-noise ratio.
Aspect 9: The method of any of Aspects 1-8, wherein the group of resource elements via which the DMRS is transmitted comprises one or more resource element group bundles, and the indication of the capability for performing the additional-resource-element channel estimation is included in the capability information based at least in part on a size of a resource element group bundle of the one or more resource element group bundles.
Aspect 10: The method of any of Aspects 1-9, wherein the indication of the capability for performing the additional-resource-element channel estimation includes an indication of whether the UE is capable of performing the additional-resource-element channel estimation per frequency range configured for the UE, per frequency band configured for the UE, per frequency band combination configured for the UE, or a combination thereof.
Aspect 11: The method of any of Aspects 1-10, further comprising: receiving information indicating that the additional-resource-element channel estimation is to be performed, the additional-resource-element channel estimation being performed based at least in part on receiving the indication.
Aspect 12: The method of any of Aspects 1-11, further comprising: receiving information indicating that the additional-resource-element channel estimation is not expected to be performed; and performing the additional-resource-element channel estimation.
Aspect 13: The method of any of Aspects 1-12, further comprising: transmitting a channel estimation report indicating a result of performing the additional-resource-element channel estimation.
Aspect 14: The method of any of Aspects 1-13, wherein a first quantity of covered CCEs associated with a PDCCH is modified based at least in part on the additional-resource-element channel estimation being performed.
Aspect 15: The method of Aspect 14, wherein performing channel estimation utilizing only the DMRS is associated with a second quantity of CCEs associated with the PDCCH, wherein the first quantity of CCEs corresponds to the second quantity of CCEs multiplied by a factor, and wherein the factor is an integer that is greater than one.
Aspect 16: The method of any of Aspects 1-15, further comprising: receiving information indicating whether the additional-resource-element channel estimation is expected to be performed for each search space of a group of search spaces associated with the UE.
Aspect 17: The method of Aspect 16, wherein a quantity of covered CCEs associated with a PDCCH for a search space, of the group of search spaces, comprises a first quantity based at least in part on the additional-resource-element channel estimation is expected to be performed for the search space and comprises a second quantity based at least in part on the additional-resource-element channel estimation is not expected to be performed for the search space.
Aspect 18: A method of wireless communication performed by a network node, comprising: receiving capability information that includes information indicating a capability for performing additional-resource-element channel estimation; and transmitting information indicating whether the additional-resource-element channel estimation is expected to be performed based at least in part on the capability information.
Aspect 19: The method of Aspect 18, further comprising: transmitting a communication that includes a DMRS; and receiving a channel estimation report indicating a result of the additional-resource-element channel estimation being performed, wherein channel estimation is performed utilizing a group of resource elements via which the DMRS is transmitted and a group of additional resource elements via which the communication is transmitted.
Aspect 20: The method of Aspect 19, wherein the communication comprises a PDCCH or a PDSCH.
Aspect 21: The method of Aspect 19, wherein the resource elements via which the DMRS is transmitted and the group of additional resource elements comprise all of the resource elements via which the communication is transmitted.
Aspect 22: The method of Aspect 19, wherein the capability information includes an indication of an expected improvement of a channel estimation parameter based at least in part on performing the additional-resource-element channel estimation relative to utilizing only the DMRS to perform the channel estimation, and wherein whether the additional-resource-element channel estimation is expected to be performed is determined based at least in part on the expected improvement of the channel estimation parameter.
Aspect 23: The method of Aspect 22, wherein the channel estimation parameter comprises a signal-to-noise ratio.
Aspect 24: The method of Aspect 22, wherein the information indicating whether the additional-resource-element channel estimation is expected to be performed is determined based at least in part on whether a difference between a first value and a second value satisfies a threshold, where the first value corresponds to an expected value of a channel estimation parameter that is determined based at least in part on performing the additional-resource-element channel estimation, and wherein the second value corresponds to an expected value of the channel estimation parameter that is determined based at least in part on utilizing only the DMRS to perform the channel estimation.
Aspect 25: The method of Aspect 24, wherein the channel estimation parameter comprises a signal-to-noise ratio.
Aspect 26: The method of any of Aspects 18-25, wherein a validity of the information indicating the capability for performing the additional-resource-element channel estimation is determined based at least in part on a size of a resource element group utilized to transmit a DMRS.
Aspect 27: The method of any of Aspects 18-26, wherein the information indicating the capability for performing the additional-resource-element channel estimation includes an indication of capability for performing the additional-resource-element channel estimation per configured frequency range, per configured frequency band, per configured frequency band combination, or a combination thereof.
Aspect 28: The method of any of Aspects 18-27, wherein a first quantity of covered CCEs associated with a PDCCH is modified based at least in part on the additional-resource-element channel estimation being performed.
Aspect 29: The method of Aspect 28, wherein performing channel estimation utilizing only a group of resource elements via which a DMRS is transmitted is associated with a second quantity of CCEs associated with the PDCCH, wherein the first quantity of CCEs corresponds to the second quantity of CCEs multiplied by a factor, and wherein the factor comprises an integer that is greater than one.
Aspect 30: The method of any of Aspects 18-29, further comprising: transmitting information indicating whether the additional-resource-element channel estimation is expected to be performed for each search space of a group of search spaces associated with a UE.
Aspect 31: The method of Aspect 30, wherein a quantity of covered CCEs associated with a PDCCH for a search space, of the group of search spaces, comprises a first quantity when the additional-resource-element channel estimation is expected to be performed for the search space and comprises a second quantity when the additional-resource-element channel estimation is not expected to be performed for the search space.
Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.
Aspect 33: An apparatus for wireless communication at a device, the apparatus comprising one or more memories and one or more processors coupled to the one or more memories, the one or more processors configured to cause the device to perform the method of one or more of Aspects 1-31.
Aspect 34: An apparatus for wireless communication, the apparatus comprising at least one means for performing the method of one or more of Aspects 1-31.
Aspect 35: A non-transitory computer-readable medium storing code for wireless communication, the code comprising instructions executable by one or more processors to perform the method of one or more of Aspects 1-31.
Aspect 36: A non-transitory computer-readable medium storing a set of instructions for wireless communication, the set of instructions comprising one or more instructions that, when executed by one or more processors of a device, cause the device to perform the method of one or more of Aspects 1-31.
Aspect 37: A device for wireless communication, the device comprising a processing system that includes one or more processors and one or more memories coupled with the one or more processors, the processing system configured to cause the device to perform the method of one or more of Aspects 1-31.
Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software.

The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit capability information that includes an indication of a capability for performing an additional-resource-element channel estimation; and
receive a communication that includes a demodulation reference signal (DMRS), wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.

2. The UE of claim 1, wherein the communication comprises a physical downlink control channel (PDCCH) or a physical downlink shared channel (PDSCH).

3. The UE of claim 1, wherein the resource elements via which the DMRS is transmitted and the group of additional resource elements comprise all of the resource elements via which the communication is transmitted.

4. The UE of claim 1, wherein the capability information includes an indication of an expected improvement of a channel estimation parameter based at least in part on the UE performing the additional-resource-element channel estimation relative to the UE utilizing only the DMRS to perform a channel estimation.

5. The UE of claim 4, wherein the channel estimation parameter comprises a signal-to-noise ratio.

6. The UE of claim 4, wherein the group of resource elements via which the DMRS is transmitted comprises one or more resource element group bundles, and wherein the expected improvement of the channel estimation parameter is determined based at least in part on a size of a resource element group bundle of the one or more resource element group bundles.

7. The UE of claim 1, wherein the indication of the capability for performing the additional-resource-element channel estimation is included in the capability information based at least in part on a difference, between an expected value of a channel estimation parameter that is determined based at least in part on performing the additional-resource-element channel estimation, and an expected value of the channel estimation parameter that is determined based at least in part on utilizing only the DMRS to perform the channel estimation, satisfying a threshold.

8. The UE of claim 7, wherein the channel estimation parameter comprises a signal-to-noise ratio.

9. The UE of claim 1, wherein the group of resource elements via which the DMRS is transmitted comprises one or more resource element group bundles, and wherein the indication of the capability for performing the additional-resource-element channel estimation is included in the capability information based at least in part on a size of a resource element group bundle of the one or more resource element group bundles.

10. The UE of claim 1, wherein the indication of the capability for performing the additional-resource-element channel estimation includes an indication of whether the UE is capable of performing the additional-resource-element channel estimation per frequency range configured for the UE, per frequency band configured for the UE, per frequency band combination configured for the UE, or a combination thereof.

11. The UE of claim 1, wherein the one or more processors are further configured to cause the UE to:
receive information indicating that the additional-resource-element channel estimation is to be performed, wherein the additional-resource-element channel estimation is performed based at least in part on receiving the indication.

12. The UE of claim 1, wherein the one or more processors are further configured to cause the UE to:
receive information indicating that the additional-resource-element channel estimation is not expected to be performed; and
perform the additional-resource-element channel estimation.

13. The UE of claim 1, wherein the one or more processors are further configured to cause the UE to:
transmit a channel estimation report indicating a result of performing the additional-resource-element channel estimation.

14. The UE of claim 1, wherein a first quantity of covered control channel elements (CCEs) associated with a physical downlink control channel (PDCCH) is modified based at least in part on the additional-resource-element channel estimation being performed.

15. The UE of claim 14, wherein performing channel estimation utilizing only the DMRS is associated with a second quantity of CCEs associated with the PDCCH, wherein the first quantity of CCEs corresponds to the second quantity of CCEs multiplied by a factor, and wherein the factor is an integer that is greater than one.

16. The UE of claim 1, wherein the one or more processors are further configured to cause the UE to:
receive information indicating whether the additional-resource-element channel estimation is expected to be performed for each search space of a group of search spaces associated with the UE.

17. The UE of claim 16, wherein a quantity of covered control channel elements (CCEs) associated with a physical downlink control channel (PDCCH) for a search space, of the group of search spaces, comprises a first quantity based at least in part on the additional-resource-element channel estimation is expected to be performed for the search space and comprises a second quantity based at least in part on the additional-resource-element channel estimation is not expected to be performed for the search space.

18. A network node for wireless communication, comprising:
one or more memories; and
one or more processors, coupled to the one or more memories, configured to cause the network node to:
receive capability information that includes information indicating a capability for performing additional-resource-element channel estimation; and
transmit information indicating whether the additional-resource-element channel estimation is expected to be performed based at least in part on the capability information.

19. The network node of claim 18, wherein the one or more processors are further configured to cause the network node to:
transmit a communication that includes a demodulation reference signal (DMRS); and
receive a channel estimation report indicating a result of the additional-resource-element channel estimation being performed, wherein channel estimation is performed utilizing a group of resource elements via which the DMRS is transmitted and a group of additional resource elements via which the communication is transmitted.

20. A method of wireless communication performed by a user equipment (UE), comprising:
transmitting capability information that includes an indication of a capability for performing an additional-resource-element channel estimation; and
receiving a communication that includes a demodulation reference signal (DMRS), wherein the communication is transmitted via a plurality of resource elements, and wherein the additional-resource-element channel estimation is performed utilizing a group of resource elements, of the plurality of resource elements, via which the DMRS is transmitted and a group of additional resource elements, of the plurality of resource elements, via which the communication is transmitted.
